(19) United States
(12) Patent Application Publication
(10) Pub. No.: US 2010/0158594 A1
(43) Pub. Date: Jun. 24, 2010

(54) SKEW CORRECTION DEVICE AND RECORDING APPARATUS

(75) Inventor: Yutao KOBAYASHI, Tatsuno-machi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/639,261

(22) Filed: Dec. 16, 2009

(30) Foreign Application Priority Data
Dec. 24, 2008 (JP) 2008-328777

(51) Int. Cl. G03G 15/00; B65H 9/00

(52) U.S. Cl. 399/395; 271/229

(57) ABSTRACT

A skew correction device which performs positional correction of a sheet while a tip end of the sheet transported in accordance with rotation of a transport roller comes into contact with a gate member so as to deform the sheet to be bent, includes: an upper guide member which is disposed between the transport roller and the gate member in a transport direction of the sheet and includes a restraining section which restrains bending deformation of the sheet and a contact range with respect to the sheet when the sheet is restrained is changeable.

### BACKGROUND

1. Technical Field

The present invention relates to a skew correction device and a recording apparatus which is provided with the skew correction device.

2. Related Art

In the past, as a skew correction device which carries out positional correction when a sheet such as a recording paper is obliquely transported, there is a transport apparatus including a skew correction device which aligns the sheet while the tip end of the sheet transported by a transport roller comes into contact with a gate member such as a resist roller so as to deform the sheet to be bent (for example, JP-A-10-218433).

In the transport apparatus as described in JP-A-10-218433, the transport roller is driven to rotate for a predetermined period of time in a state where the tip end of the sheet comes into contact with the gate member. Therefore, when the sheet is obliquely transported, the sheet rotates around one corner of the tip end which firstly comes into contact with the gate member until the other corner of the tip end comes into contact with the gate member, so that the positional correction is carried out. Then, a restraining member is provided all over the width of the sheet so as to restrain bending deformation of the sheet from the upper side. Therefore, a bending degree of the sheet is controlled and the sheet is pushed toward the gate member by reactive force generated from the pressing member, so that rotation of the sheet is accelerated.

In a case where the rigidity of sheets to be subjected to the positional correction is low, when the sheet is uniformly restrained on its relatively wide range in a width direction, the sheets can rotate while a skew can be prevented from occurring. Therefore, the restraining member is provided all over the width of the sheet, so that the positional correction can be reliably carried out. On the other hand, when the rigidity of the sheets is high, contact pressure between the sheet and the restraining member becomes higher. Therefore, when the contact pressure between the sheet and the restraining member becomes higher, there is a problem in that rotation for carrying out the positional correction is hindered by the frictional force occurring between the sheet and the restraining member. In addition, when the rigidity or the size of the sheet differs, a bending direction is also changed. Therefore, it is difficult to determine uniformly the size or arrangement of the restraining member in order to optimize the positional correction for all kinds of sheets.

In other words, the proper size or proper arrangement of the restraining member differs depending on the kind of sheet to be subjected to the positional correction. Therefore, in the transport apparatus according to the related art, there is a problem in that the positional correction cannot be properly carried out in correspondence with the different kinds of sheet. Further, in addition to the transport apparatus, when different kinds of sheet are subjected to the skew correction, the above-mentioned problem commonly occurs.

### SUMMARY

An advantage of some aspects of the invention is to provide a skew correction device and a recording apparatus including the skew correction device, which can properly carry out skew correction even when the kind of sheet differs.

According to an aspect of the invention, there is provided a skew correction device which performs positional correction of a sheet while a tip end of the sheet transported in accordance with rotation of a transport roller comes into contact with a gate member so as to deform the sheet to be bent, including: an upper guide member which is disposed between the transport roller and the gate member in a transport direction of the sheet and includes a restraining section which restrains bending deformation of the sheet and a contact range with respect to the sheet when the sheet is restrained is changeable.

According to such a configuration, the upper guide member includes the restraining section which can change the contact range with respect to the sheet when the sheet is restrained. Therefore, it is possible to carry out the skew correction properly even when the kind of sheet differs.

In the skew correction device of the invention, the contact range is changed by increasing or decreasing a laying range of the restraining section.

According to such a configuration, the laying range of the restraining section is increased or decreased so as to change the contact range with respect to the sheet. Therefore, it is possible to carry out the skew correction properly even when the kind of sheet differs.

In the skew correction device of the invention, the length of the restraining section is changeable in at least one direction of a transport direction and a width direction of the sheet.

According to such a configuration, the length of the restraining section is changeable in at least one direction of the transport direction and the width direction of the sheet. Therefore, it is possible to carry out the skew correction properly even when the kind of sheet differs.

In the skew correction device of the invention, the restraining section extends along the transport direction in a state where a side of the restraining section facing the gate member is higher than the other side of the restraining section facing the transport roller. In addition, a contact angle with respect to the sheet is changeable by changing an inclination angle with respect to the transport direction.

According to such a configuration, the contact angle of the restraining section with respect to the sheet is changeable. Therefore, it is possible to carry out the skew correction properly even when the kind of sheet differs.

In the skew correction device of the invention, the restraining section includes at least one row of curved surface sections, which is in a partially cylindrical shape of which the cross section is in an arcuate shape and which extends along the transport direction. In addition, the curved surface section comes into contact with the sheet.

According to such a configuration, the curved surface section which is formed on the restraining section comes into contact with the sheet, so that the frictional force occurring when the sheet comes into slidable contact with the restraining section is reduced. Therefore, the sheet can be smoothly transported and rotated.

In the skew correction device of the invention, when the positional correction is carried out on the sheet with low rigidity, the restraining section is laid all over the width of the sheet. In addition, when the positional correction is carried out on the sheet with high rigidity, the restraining section is laid in a range from 10% to 25% in the center with respect to the width of the sheet.

According to such a configuration, when the positional correction is carried out on the sheet with low rigidity, the restraining section is laid all over the width of the sheet, so that the skew of the sheet is prevented. Therefore, it is possible to carry out the skew correction properly. On the other hand, when the positional correction is carried out on the sheet with high rigidity, the restraining section is laid in a range from 10% to 25% in the center with respect to the width of the sheet, so that the sheet is allowed to rotate. Therefore, it is possible to carry out the skew correction properly.

In the skew correction device of the invention, the upper guide member further includes an elastic member which after the tip end of the sheet comes into contact with the gate member, receives pressing force in accordance with bending deformation of the sheet so as to be elastically deformed.

According to such a configuration, after the tip end of the sheet comes into contact with the gate member, the elastic member receives the pressing force in accordance with the bending deformation of the sheet so as to be elastically deformed, so that the bending deformation controlled by the restraining section is allowed. Therefore, the burden on the sheet can be reduced.

According to another aspect of the invention, there is provided a recording apparatus which includes: the skew correction device as described above; and a recording unit for performing a recording process of the sheet which is subjected to the positional correction.

According to such a configuration, the same effect as that of the skew correction device can be obtained.

### BRIEF DESCRIPTION OF THE DRAWINGS

The invention will be described with reference to the accompanying drawings, wherein like numbers reference like elements.

FIG. 1 is a diagram schematically illustrating a configuration of a recording apparatus according to an embodiment.

FIG. 2 is a plan view illustrating the vicinity of an upper guide member.

FIG. 3 is a side view illustrating a configuration and an operation of an upper guide member in a state before a sheet comes into contact with a resist roller.

FIG. 4 is a side view illustrating a configuration and an operation of an upper guide member in a state after a sheet comes into contact with a resist roller.

FIG. 5 is a perspective view illustrating a configuration of a pressing section.

### DESCRIPTION OF EXEMPLARY EMBODIMENTS

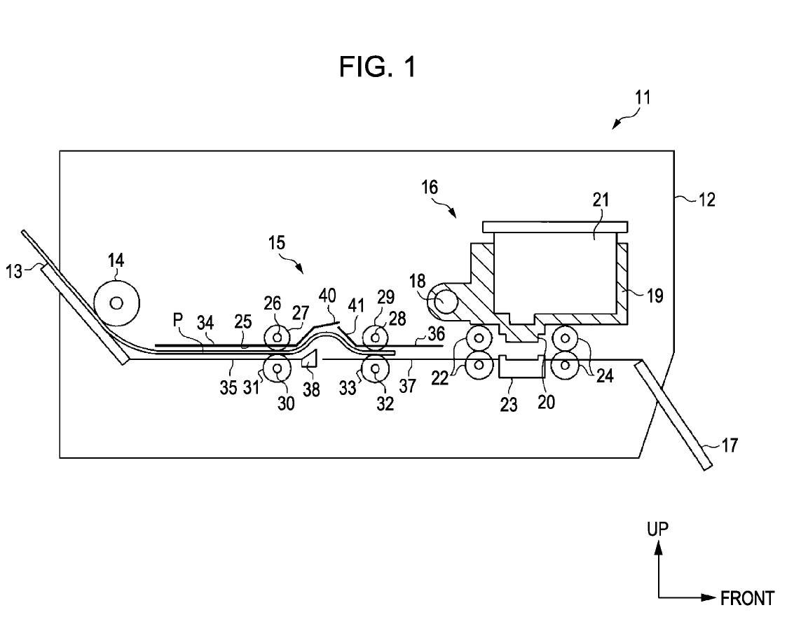

Hereinafter, the invention will be described through embodiments in which a printer is specified as a kind of a recording apparatus with reference to FIGS. 1 to 5. Further, in the following descriptions, when “longitudinal direction”, “horizontal direction”, and “vertical direction” are referred to, it is assumed that these directions are indicated with reference to directions of an arrow illustrated in each drawing.

A printer 11 as shown in FIG. 1 is a large-scale ink jet printer which can perform printing on a size of A1 or B1. The printer 11 is provided with a main frame 12, and a set unit 13, which can set the sheet P such as a recording paper, in a back surface side of the main frame 12.

In addition, the main frame 12 accommodates a feeding roller 14 for delivering the sheets P which are set on the set unit 13, a skew correction device 15 for performing positional correction of the delivered sheets P, and a printing device 16 to implement recording by performing a print process on the sheets P which are subjected to the positional correction. Furthermore, in a front surface side of the main frame 12, a discharge unit 17 is provided to guide the sheets P which are subjected to the print process and discharged from the main frame 12.

The printing device 16 extends in a horizontal direction (a direction perpendicular to the paper in FIG. 1). The printing device 16 is provided with a rod-shaped guide shaft 18 of which both the right and left ends are supported by the main frame 12, a carriage 19 which is supported by the guide shaft 18 so as to be reciprocally moved in the horizontal direction, and a recording head 20 which is provided on a lower surface side of the carriage 19. Then, the carriage 19 can be moved in the horizontal direction, which is a scanning direction, in accordance with the driving of a carriage motor (not shown).

In the main frame 12, an ink cartridge (not shown) containing ink is mounted so as to be attached thereto or detached therefrom, and the mounted ink cartridge is connected to an upstream end of an ink supply passage (not shown). On the carriage 19, a valve unit 21 is mounted such that a downstream end of the ink supply passage is connected thereto. Then, the ink contained in the ink cartridge is pressured and fed to the valve unit 21 through the ink supply passage by a pressing pump (not shown), so that the ink is supplied from the valve unit 21 to the recording head 20. In addition, on the lower surface side of the recording head 20, nozzle openings (not shown) are provided so as to eject the ink.

On the lower side of the carriage 19, there are provided a sending roller pair 22 disposed in a rear position of the recording head 20, a platen 23 which is a support base of the sheet P disposed in a lower position of the recording head 20 and in a forward position of the sending roller pair 22, and a sending roller pair 24 disposed in a forward position of the platen 23. Then, a sending process of transporting the sheet P by a predetermined distance toward the forward side which is the downstream side in the transport direction by the sending roller pairs 22 and 24, and a print process of ejecting ink from the nozzle openings of the recording head 20 which is moved in the scanning direction (horizontal direction) together with the carriage 19 are alternatively carried out, so that the recording process is carried out on the sheet P.

In addition, the skew correction device 15 is provided in the middle of the transport passage 25 through which the sheet P is transported toward the printing device 16. Specifically, in order to transport the sheet P, which is delivered by the feeding roller 14, toward the forward side which is the downstream side in the transport direction, there are provided on the transport passage 25 with a metal transport roller 27 which rotates in accordance with rotational driving of a driving shaft 26 and a resist roller 29 which is disposed in the downstream side (forward side) in the transport direction from the transport roller 27 and is driven in accordance with rotational driving of a driving shaft 28. Therefore, on the lower side of the transport roller 27, a driven roller 31 made of hard rubber, which rotates about a rotary shaft 30 in accordance with the transport roller 27, is provided so as to make a pair with the transport roller 27. In addition, on the lower side of the resist roller 29, a driven roller 33, which rotates about a rotary shaft 32 in accordance with rotation of the resist roller 29, is provided so as to make a pair with the resist roller 29.

In the skew correction device 15, by making the transport roller 27 rotate in a counterclockwise direction in FIG. 1 in a state where the resist roller 29 stops rotating, the sheet P is transported toward the forward side so as to come into contact with the resist roller 29. Then, from this state, the transport roller 27 further rotates by a predetermined distance, so that skew correction is carried out on the sheet P.

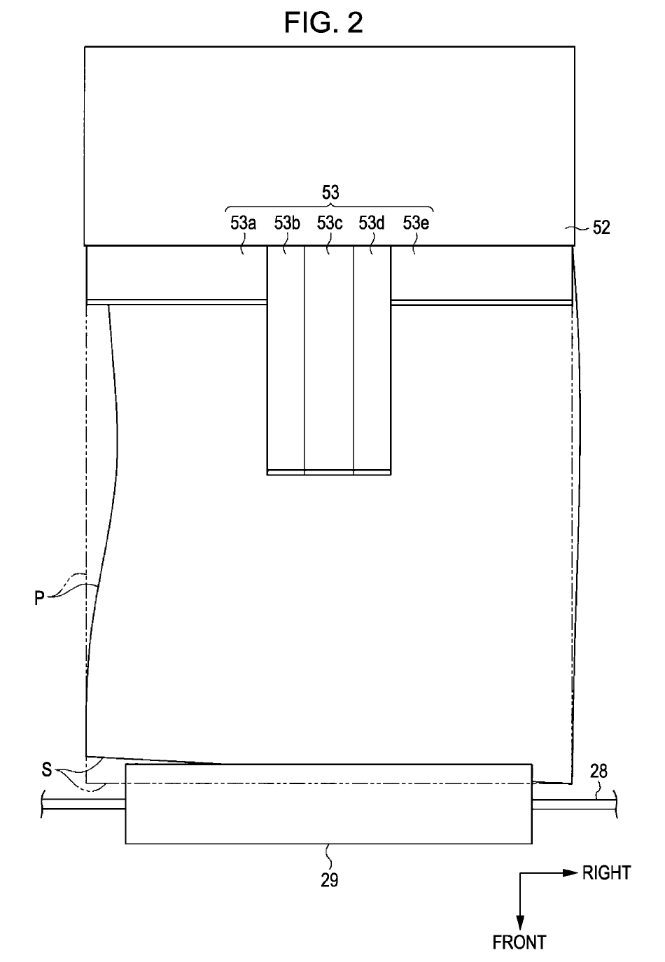

Here, as shown in FIG. 2, the skew correction means that positional correction is carried out on the sheet P such that the tip end S extending in a horizontal direction of the rectangular sheet P in plan view is to be an aligned state (the state illustrated in a double-dotted line as shown in FIG. 2) perpendicular to the transport direction (longitudinal direction). That is, in order to carry out the recording process properly, it is necessary for the sheet P to be in the aligned state so as to be supplied to the printing device 16. However, since the tip end S of the sheet P is in a skewed state (the state illustrated in a solid line as shown in FIG. 2) not perpendicular to the transport direction when the sheet is delivered or transported, the positional correction of the sheet P is carried out by the skew correction device 15.

Specifically, for example, when the sheet P is transported in the skewed state where the right end side of the sheet P is preceding, the right end side of the tip end S of the sheet P first comes into contact with the resist roller 29. Then, when the transport roller 27 is further driven to rotate from this state, the sheet P is slowly bent upward and rotates around the right end side which comes into contact with the resist roller 29, and the left end side of the tip end S comes into contact with the resist roller 29, so that the positional correction is carried out. After such a positional correction is carried out, the resist roller 29 rotates in the counterclockwise direction in FIG. 1, so that the aligned sheet P is transported to the printing device 16.

Next, the configuration of the skew correction device 15 will be described.

As shown in FIG. 1, on the transport passage 25, a transport passage forming member 34 which is disposed in the vicinity of the transport roller 27, a transport passage forming member 35 which is disposed in the vicinity of the driven roller 31, a transport passage forming member 36 which is disposed in the vicinity of the resist roller 29, and a transport passage forming member 37 which is disposed in the vicinity of the driven roller 33. Then, the sheet P is transported from the upstream (back side) to the downstream (front side) of the transport passage 25, while the surface (upper surface) subjected to the print process is guided so as to face the transport passage forming members 34 and 36 and the rear surface (lower surface) is guided so as to face the transport passage forming members 35 and 37.

Between the transport passage forming members 35 and 37, there is disposed a lower guide member 38 which raises the tip end of the transported sheet P upward so as to cause bending deformation to start. In addition, on the front end side of the transport passage forming member 34, an upper guide member 40 is provided so as to guide the upper surface side of the sheet P which is guided to the lower guide member 38 and faces in an inclined direction with respect to the transport direction. Further, on the back end side of the transport passage forming member 36, a guide plate 41 is provided so as to guide the tip end of the sheet P to the resist roller 29. That is, in the skew correction device 15, the sheet P is induced by the lower guide member 38 and the bending deformation of the sheet P is controlled by the upper guide member 40 and the guide plate 41, so that the positional correction is carried out with high accuracy. Further, in FIG. 2, in order to clearly illustrate the sheet P, the transport passage forming member 36 and the guide plate 41 are not shown in the drawing.

Next, the upper guide member 40 will be described which is disposed between the transport roller 27 and the resist roller 29 in the transport direction of the sheet P.

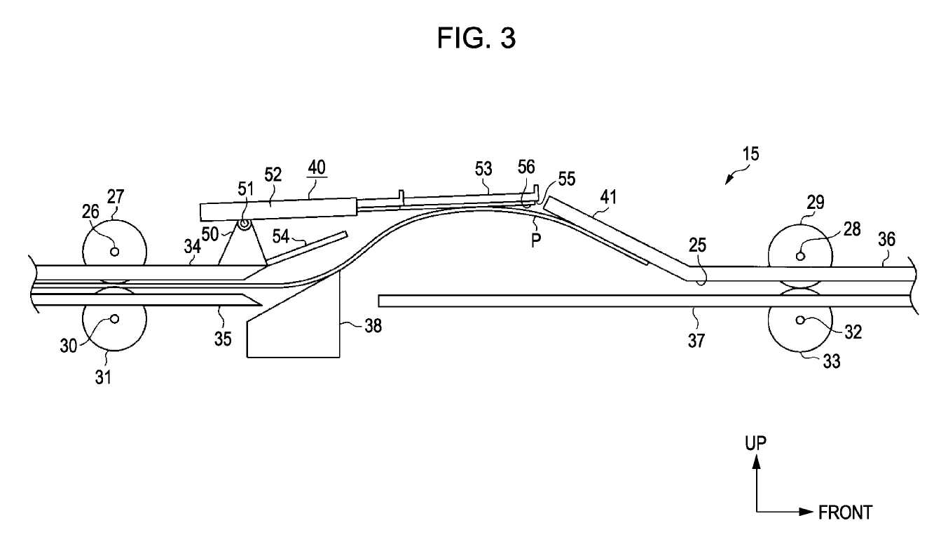

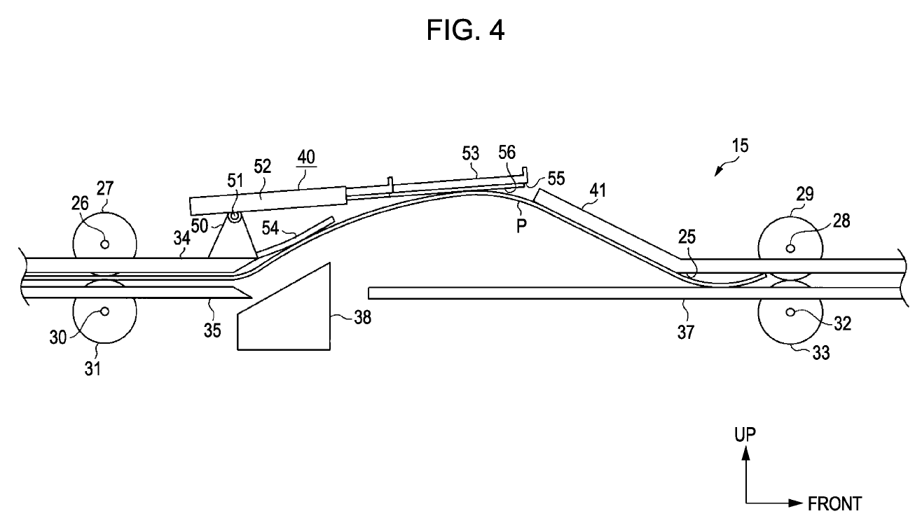

As shown in FIGS. 3 and 4, the upper guide member 40 is provided with a base section 50 which is fixed in the vicinity of the front end of the transport passage forming member 34, a case section 52 in a bottomed box shape which is supported on the upper end of the base section 50 via a spindle 51 and of which the front side is opened, plural plate-like restraining members 53 of which the base end sides are accommodated into the case section 52, and an elastic member 54 of which the base end side is supported on the front side of the base section 50. Further, the elastic member 54 is provided upright on the case section 52 in a state where the elastic member 54 is inclined in an upper direction.

Each restraining member 53 rotates the case section 52 around the spindle 51 which extends in the horizontal direction (a direction perpendicular to the paper in FIGS. 3 and 4), so that the inclination angle is changeable. For example, in FIGS. 3 and 4, when the case section 52 rotates in the counterclockwise direction, the inclination angle of each restraining member 53 increases. Then, when the positional correction of the sheet P is carried out, the case section 52 is fixed on the base section 50 by a fixing mechanism (not shown) in a state where each restraining member 53 is inclined such that the side of each restraining member 53 facing the resist roller 29 (front side) is higher than the other side thereof facing the transport roller 27. Therefore, the inclination angle of each restraining member 53 is fixed.

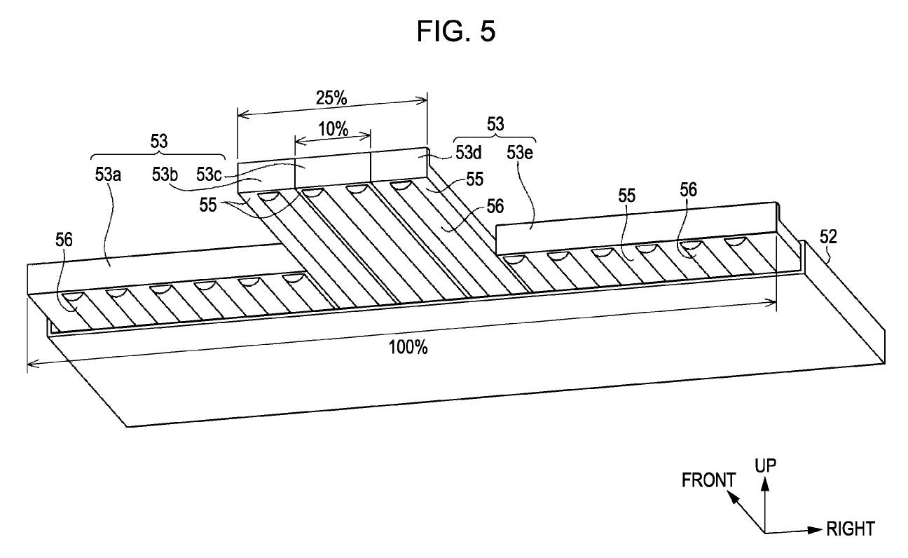

As shown in FIG. 5, five restraining members 53 (53a, 53b, 53c, 53d, and 53e) are accommodated to the case section in a state where they are disposed parallel to each other in the horizontal direction. Then, a restraining section 55 is configured with the lower surface of each restraining member 53. The restraining section 55 can restrain the sheet P downward so as to be bent. Further, in FIG. 5, the base section 50 of the upper guide member 40, the spindle 51, and the elastic member 54 is omitted.

All of the lengths of each restraining member 53 in the transport direction are equal to each other, and the length is longer than that of the case section 52 in the transport direction. Therefore, the tip end side (the front end side) of each restraining member 53 is in a state where a part thereof is always exposed from the case section 52. In this case, when the restraining member 53 is accommodated into the case section 52 at maximum, the restraining section 55 is guided to the lower guide member 38 so as not to come into contact with the sheet P, which faces in an inclined direction with respect to the transport direction, before the sheet P comes into contact with the resist roller 29. On the other hand, when the restraining member 53 is withdrawn from the case section 52 at maximum, the tip end (front end) of the restraining section 55 extends to the vicinity of the back end of the guide plate 41. Further, when there is secured a sufficient space in the longitudinal direction, all of the restraining members 53 may be accommodated to the case section 52.

Then, when being withdrawn from the case section 52 by an arbitrary length, each restraining member 53 can be individually fixed on the position by a lock member (not shown). That is, the restraining section 55 is configured such that the length is changeable in the transport direction of the sheet P.

The restraining member 53c, which is disposed at a position corresponding to the center of the sheet P in the width direction (horizontal direction), is set such that the length (width) in the horizontal direction of the restraining section 55 configured with the lower surface thereof corresponds to about 10% of the maximum width of the sheet P which can be printed by the printer 11. In addition, the restraining members 53b and 53d which are disposed at both left and right sides of the restraining member 53c and the restraining members 53a and 53e which are disposed at both left and right ends of the restraining member 53c are aligned in a left-right symmetric manner. Then, the width of the restraining section 55, which corresponds to three of the restraining members 53b, 53c, and 53d disposed at the center, is set to correspond to about 25% of the maximum width of the sheet P. In addition, the width of the restraining section 55, which corresponds to all of the restraining members 53a to 53e, is set to equal (about 100%) the maximum width of the sheet P.

Each restraining member 53 can be separately accommodated to and withdrawn from the case section 52. However, in this embodiment, the restraining member 53 is withdrawn and fixed in three patterns, such as only the restraining member 53c disposed at the center is withdrawn and fixed as Pattern 1, three restraining members 53b to 53d disposed at the center are withdrawn and fixed as Pattern 2, and all of the restraining members 53a to 53e are withdrawn and fixed as Pattern 3. Therefore, the length of the restraining section 55 is changeable in the width direction of the sheet P in three stages. That is, by changing the withdrawn state of the restraining member 53, the laying range of the restraining section 55 is increased or decreased, so that a contact range of the restraining member 53 with respect to the sheet P when the sheet P is restrained is changed. Further, FIGS. 2 to 5 show the withdrawn state of Pattern 2.

In order to suppress the influence of the frictional force occurring when the restraining member 53 is withdrawn from the case section 52 or when the sheet P comes into contact with the restraining section 55, one or more pieces of smooth curved surface sections 56 in a partially cylindrical shape of which the cross section is in an arcuate shape (or a partially circular shape) are formed in rows on the restraining section 55 configured with the respective restraining members 53 so as to extend in the longitudinal direction. Therefore, when the restraining section 55 restrains the sheet P, the curved surface sections 56 formed on the restraining section 55 come into contact with the sheet P. Further, in this embodiment, two rows of the curved surface sections 56 are provided at the restraining member 53c positioned at the center, one row thereof is provided at the restraining members 53b and 53c positioned at both sides of the center, and six rows thereof are provided at the restraining members 53a and 53e positioned at both left and right of the center. However, the arrangement and number of rows of the curved surface section 56 can be arbitrarily set in a horizontal direction.

Next, the operation of the upper guide member 40 configured as described above will be described.

First, in skew correction, the inclination angle of the restraining section 55 is set. That is, the restraining section 55 extends along the transport direction in a state where the side of the restraining section 55 facing the resist roller 29 is higher than the other side thereof facing the transport roller 27, and the inclination angle of the restraining section 55 with respect to the transport direction of the restraining member 53 is changed. Therefore, a contact angle on the sheet P is changed according to the kind of sheet P.

The restraining section 55 restrains the sheet P downward which is raised upward by the lower guide member 38, so that the bending degree of the sheet P is controlled such that the sheet P is guided to the guide plate 41. In addition, after the sheet P comes into contact with the resist roller 29, the restraining section 55 serves to accelerate the rotation by restraining the sheet P toward the resist roller 29 using the reactive force generated from the restraining section 55.

Then, in the case where the rigidity of the sheet P to be transported is high, when the tip end of the sheet P is raised upward by the lower guide member 38, the bending top portion of the sheet P is shifted to the fore part in the transport direction and to the upper part in the vertical direction in comparison with that in the case of the sheet P with low rigidity. Therefore, when the rigidity of the sheet P is high, the inclination angle of the restraining section 55 is set to be low, so that the sheet P is pushed such that the bending degree of the sheet P is small in order to guide the sheet P to the lower side of the guide plate 41.

After the inclination angle of the restraining section 55 is set, the restraining member 53 is selectively withdrawn according to the rigidity of the sheet P to be transported so as to be fixed, so that the width of the restraining section 55, that is, the laying range in the width direction of the sheet P is set.

In the skew correction device 15 according to the embodiment, the sheet P with high rigidity is subjected to the positional correction in the withdrawn state of Pattern 2 in which the restraining members 53b, 53c, and 53d are withdrawn from the case 52 and the restraining members 53a and 53e are accommodated into the case 52 at maximum. In addition, the sheet P, which has high rigidity and a narrow width in the horizontal direction, is subjected to the positional correction in the withdrawn state of Pattern 1 in which only the restraining member 53c is withdrawn from the case section 52 and the other restraining members 53a, 53b, 53d, and 53e are accommodated into the case section 52 at maximum. Then, the sheet P with low rigidity is subjected to the positional correction in the withdrawn state of Pattern 3 in which all of the restraining members 53 are withdrawn from the case section 52.

Therefore, as shown in FIG. 2, for example, when the positional correction is carried out in the withdrawn state of Pattern 2, the vicinity of the center of the sheet P is restrained by the curved surface section 56 of the restraining section 55 of which the restraining members 53b to 53d are set to correspond to about 25% of the width of the sheet P. In this case, since the rigidity of the sheet P is high, the sheet P comes into contact with the restraining section 55 with contact pressure higher than that of the sheet P with low rigidity, and the left end side of the sheet P pushed by the reactive force rotates. At this time, since the rotating end side (left end side) in the width direction does not come into contact with the restraining section 55, the influence of the frictional force which acts against the rotation is suppressed.

That is, by setting the laying range of the restraining section 55 with respect to the width of the sheet P to be less than ⅓ of the entire width, ⅓ or more of the sheet P on both end sides in the width direction is separated from the restraining section 55, so that the influence of the frictional force which acts against the rotation is suppressed. Further, when the sheet P is obliquely passed, the contact position of the sheet P for contacting with the restraining member 53 disposed at the center becomes the end of the sheet P. Therefore, when the laying range of the restraining section 55 is too narrow compared with the width of the sheet P, the sheet P cannot be pressed in a balanced manner in the width direction. For this reason, it is preferable that the laying range of the restraining section 55 corresponding to the sheet P with high rigidity be set to range from ⅕ to ⅓ of the width of the sheet P. Further, in this embodiment, also considering that the printer 11 performs printing according to plural sizes of the sheets, the laying range of the restraining section 55 corresponding to the sheet P with high rigidity is set to 25% less than ⅓ of the maximum width of the sheet P which can be printed by the printer 11.

From this point of view, when the positional correction is carried out in the withdrawn state of Pattern 1, the reactive force from the restraining member 53c is applied only on the vicinity of the center of the sheet P even though the width of the sheet P is narrowed. Therefore, while the influence of the frictional force is suppressed, the sheet P can be rotated.

Further, even when the positional correction is carried out using only the restraining member 53c corresponding to 10% of the maximum width of the sheet P, the positional correction can be carried out without seriously losing the balance. Therefore, when there is a need to accelerate the rotation, the positional correction may be carried out on the sheet P with the maximum width only by the restraining member 53c of Pattern 1. Alternatively, the positional correction may also be carried out by the restraining section 55 which is set to a laying range from 20% to 30% of the width of the sheet P. Further, in addition to the case where the positional correction is carried out on the sheet P with a narrow width, particularly even the case where the rigidity of the sheet P or the case where surface roughness of the sheet P is high, the positional correction can be effectively carried out by setting the withdrawn state of Pattern 1.

In this regard, in the case of the sheet P with low rigidity, when the sheet P is applied with the reactive force only on the vicinity of the center thereof, there are some concerns that the sheet P may be twisted by a burden applied between the center and the end around which the sheet P rotates. For this reason, when the positional correction of the sheet P with low rigidity is carried out, the restraining section 55 of the restraining members 53a to 53e in the withdrawn state of Pattern 3, is laid all over the width of the sheet P and comes into contact with the sheet P all over the width of the sheet P. In this case, since the contact pressure of the sheet P with respect to the restraining section 55 does not become greater, the frictional force against the rotation becomes smaller. Therefore, the sheet P can smoothly rotate.

Further, in this embodiment, the restraining section 55 is configured with five restraining members 53. However, by increasing the number of the restraining members 53, it may be deal with the kind (size, rigidity, etc.) of sheet P in detail. At this time, the restraining members 53 are disposed at the center and both sides thereof with an odd number of the members so as to be aligned in a left-right symmetric manner, so that the sheet P can be restrained in the width direction in a balanced manner.

Finally, the length of the restraining section 55 in the transport direction, that is, the laying range in the transport direction is set. When the selected restraining member 53 is withdrawn from the case section 52 at maximum, the front end of the restraining section 55 extends to the vicinity of the back end of the guide plate 41. Therefore, regardless of the position of the top bending portion of the sheet P, it is possible to restrain the sheet P by the length of the restraining section 55 in the transport direction. In this case, when the contact range between the sheet P and the restraining section 55 becomes greater, the frictional force against the rotation of the sheet P becomes greater in proportion to the increased range, so that the restraining member 53 is accommodated into the case section 52 as needed in order to shorten the length of the restraining section 55 in the transport direction. In particular, when all the restraining members 53a to 53e are withdrawn from the case section 52, the burden applied on the case section 52 and the spindle 51 is greater, so that it is preferable that the restraining members 53 be accommodated into the case section 52 if it is not necessary.

The restraining members 53 restrain the sheet P at the time of correcting a skew, so that the upwardly bending deformation of the sheet P is controlled. In addition, the forwardly bending deformation of the sheet P is restrained by the guide plate 41, so that the tip end of the sheet P comes into contact with the resist roller 29, and then while the transport roller 27 rotates, the sheet P is deformed to be bent such that swelling of the sheet P increases facing the base end of the restraining section 55 as shown in FIG. 4.

Since the elastic member 54 is provided on the front side of the base section 50, when the bent portion of the sheet P is close to the vicinity of the case section 52, the elastic member 54 receives the pressing force in accordance with the bending deformation of the sheet P so as to be elastically deformed as shown in FIG. 4, so that the bending deformation of the sheet P is allowed. At this time, when the bending deformation of the sheet P is not allowed, the sheet P comes into slidable contact with the restraining section 55 and the guide plate 41 with strong contact force, so that there are some concerns that the upper surface which is a printing surface of the sheet P is marred.

Here, for example, when the restraining members 53 receive the pressing force in accordance with the bending deformation of the sheet P so as to move obliquely (or to be elastically deformed), the bending deformation of the sheet P can be allowed, but the inclination angle of the restraining section 55 is changed. Therefore, the bending degree of the sheet P cannot be accurately controlled.

In this embodiment, the restraining members 53 are fixed, and on the other hand, the bending deformation controlled by the restraining section 55 is allowed by the elastic deformation of the elastic member 54, so that the burden on the sheet P is reduced. Therefore, in the upper guide member 40 according to the embodiment, the bending degree of the sheet P is accurately controlled, and it is possible to prevent the sheet P from being marred.

According to the embodiment as described above, the following effects can be obtained.

(1) The upper guide member 40 includes the restraining section 55 which can change the contact range with respect to the sheet P when the sheet P is restrained. Therefore, it is possible to carry out the skew correction properly even when the kind of sheet P differs.

(2) The laying range of the restraining section 55 is increased or decreased so as to change the contact range with respect to the sheet P. Therefore, it is possible to carry out the skew correction properly even when the kind of sheet P differs.

(3) The length of the restraining section 55 is changeable in the transport direction and the width direction of the sheet P. Therefore, it is possible to carry out the skew correction properly even when the kind of sheet P differs.

(4) The contact angle of the restraining section 55 with respect to the sheet P is changeable. Therefore, it is possible to carry out the skew correction properly even when the kind of sheet P differs.

(5) The curved surface section 56 which is formed on the restraining section 55 comes into contact with the sheet P, so that the frictional force occurring when the sheet P comes into slidable contact with the restraining section 55 is reduced. Therefore, the sheet P can be smoothly transported and rotated.

(6) When the positional correction is carried out on the sheet P with low rigidity, the restraining section 55 is laid all over the width of the sheet P, so that the skew of the sheet P is prevented. Therefore, it is possible to carry out the skew correction properly. On the other hand, when the positional correction is carried out on the sheet P with high rigidity, the restraining section 55 is laid in a range from 10% to 25% in the center with respect to the width of the sheet P, so that the sheet is allowed to rotate. Therefore, it is possible to carry out the skew correction properly.

(7) After the tip end of the sheet P comes into contact with the resist roller 29, the elastic member 54 receives the pressing force in accordance with the bending deformation of the sheet P so as to be elastically deformed, so that the bending deformation controlled by the restraining section 55 is allowed. Therefore, the load on the sheet P can be reduced.

Further, the above-mentioned embodiment may be modified as other embodiments as described in the following.
In this embodiment, the restraining members 53 are configured to be withdrawn along the transport direction. However, for example, it may also be possible that the length of the restraining section is changed in the width direction thereof by employing restraining members which are configured to be stretchable or foldable in the width direction of the sheet P. In addition, it may also be possible that the length of the restraining section is changed in the width direction thereof by replacing the restraining section with a different width.
In the restraining section 55, there is provided a sensor to detect the contact pressure of the sheet P so as to determine the strength of the rigidity of the sheet P on the basis of the detected contact pressure, so that the width of the restraining section 55 may be changed.
The length of the restraining section 55 in the transport direction may be configured not to be changeable.
The inclination angle of the restraining section 55 may be configured not to changeable.
The restraining section 55 may be in a planar shape without being provided with the curved surface section 56.
The upper guide member 40 may be configured without being provided with the elastic member 54.
The upper guide member 40 may be configured to support the restraining member 53 in a rail shape instead of the case section 52 in the bottomed box shape.
The inclination angle, the length in the transport direction, or the width of the restraining section 55 may be changed manually. Alternatively, there may be provided a control apparatus for automatically carrying out the adjustment in accordance with the kind of sheet P to be used.
The resist roller 29 may be configured to be divided into plural pieces in the width direction.
The gate member is not limited to the resist roller 29, but may be realized as a plate-like member which can move in the vertical direction.
The sheet P is not limited to the recording paper, but may be realized as a member such as a plastic film.
The transport roller 27 is not limited to metal, but a plastic or a hard rubber may be employed. In addition, these plural kinds of the transport rollers 27 may be mixed to be used. Similarly, the driven roller 31 is not limited to hard rubber, but a metal or a plastic may be employed, or these may be mixed to be used.
In the above-mentioned embodiment, the recording apparatus is specified as the large-scale ink jet printer, but the invention is not limited thereto. For example, the skew correction device may be provided to a small-scale recording apparatus which performs printing of an A4 size, a printer operated in a different manner such as an electrophotographic method, a FAX machine, a copying machine, or a multifunction machine or the like which is provided with these plural functions. Further, there may be employed a liquid ejecting apparatus which ejects or discharges a liquid other than ink. The skew correction device may be employed in various liquid ejecting apparatuses each providing a liquid ejecting head for discharging a minute amount of liquid droplets. Further, the liquid droplet means a state of the liquid which is discharged from the liquid ejecting apparatus, which includes a liquid droplet having a tail drawn in a granular shape, a tear shape, or a thread shape. In addition, the liquid droplet as described above is not particularly limited as long as it is a material which can be ejected by the liquid ejecting apparatus. For example, any material may be employed as long as the material is in a liquid phase, and include a liquid with a high or low viscosity property, sol, gel water, and materials that flow such as inorganic solvents, organic solvents, solutions, liquid resin, liquid metal (molten metal). In addition to a liquid as one state of matter, there may be included materials in which particles of a functional material consisting of solid matter such as pigments or metal particles are dissolved, dispersed, or mixed with a solvent. In addition, as a representative example of a liquid, ink as described in the above-mentioned embodiment or liquid crystal is exemplified. Here, it is assumed that the ink includes water-based ink, oil-based ink, and various liquid compositions such as gel ink, and hot melt ink. As a specific example of the liquid ejecting apparatus, for example, a liquid ejecting apparatus which ejects a liquid in which a material such as an electrode material or a coloring material used for manufacturing color filters, a liquid crystal display, an EL (electroluminescence) display, and a surface emitting display, is dispersed or dissolved, a liquid ejecting apparatus which ejects a biological organic material used for manufacturing bio chips, a liquid ejecting apparatus which ejects a liquid as a sample used as a precision pipette, a textile printing apparatus, a micro display, or the like may be employed. Furthermore, a liquid ejecting apparatus which ejects a lubricant onto a precision machine such as a clock or a camera using a pin point, a liquid ejecting apparatus which ejects transparent resin such as ultraviolet cure resin onto a substrate in order to form lenses (optical lenses) with a minute radius used in optical communication elements, and a liquid ejecting apparatus which ejects an etching liquid such as an acid liquid or an alkali liquid in order to etch substrates may be also employed. The invention can be applied to any one of these liquid ejecting apparatuses.

What is claimed is:

1. A skew correction device which performs positional correction of a sheet while a tip end of the sheet transported in accordance with rotation of a transport roller comes into contact with a gate member so as to deform the sheet to be bent, comprising:
an upper guide member which is disposed between the transport roller and the gate member in a transport direction of the sheet and includes a restraining section which restrains bending deformation of the sheet and a contact range with respect to the sheet when the sheet is restrained is changeable.

2. The skew correction device according to claim 1,
wherein the contact range is changed by increasing or decreasing a laying range of the restraining section.

3. The skew correction device according to claim 1,
wherein the length of the restraining section is changeable in at least one direction of a transport direction and a width direction of the sheet.

4. The skew correction device according to claim 1,
wherein the restraining section extends along the transport direction in a state where a side of the restraining section facing the gate member is higher than the other side of the restraining section facing the transport roller, and
wherein a contact angle with respect to the sheet is changeable by changing an inclination angle with respect to the transport direction.

5. The skew correction device according to claim 1,
wherein the restraining section includes at least one row of curved surface sections, which is in a partially cylindrical shape of which the cross section is in an arcuate shape and which extends along the transport direction, and
wherein the curved surface section comes into contact with the sheet.

6. The skew correction device according to claim 1,
wherein when the positional correction is carried out on the sheet with low rigidity, the restraining section is laid all over the width of the sheet, and
wherein when the positional correction is carried out on the sheet with high rigidity, the restraining section is laid in a range from 10% to 25% in the center with respect to the width of the sheet.

7. The skew correction device according to claim 1,
wherein the upper guide member further includes an elastic member which after the tip end of the sheet comes into contact with the gate member, receives pressing force in accordance with bending deformation of the sheet so as to be elastically deformed.

8. A recording apparatus comprising:
the skew correction device according to claim 1; and
a recording unit for performing a recording process of the sheet which is subjected to the positional correction.
